(19) United States
(12) Patent Application Publication
(10) Pub. No.: US 2014/0211203 A1
(43) Pub. Date: Jul. 31, 2014

(54) TESTING DEVICE AND TESTING LENS MEMBER FOR TESTING CAMERA MODULE

(71) Applicant: HON HAI PRECISION INDUSTRY CO., LTD., New Taipei (TW)

(72) Inventor: CHANG-WEI KUO, New Taipei (TW)

(73) Assignee: HON HAI PRECISION INDUSTRY CO., LTD., New Taipei (TW)

(21) Appl. No.: 14/014,408

(22) Filed: Aug. 30, 2013

(30) Foreign Application Priority Data
Jan. 31, 2013 (TW) 102103840

(51) Int. Cl. G01M 11/02; G03B 17/56

(52) U.S. Cl. CPC G01M 11/02; G03B 17/565
USPC 356/124; 359/793

(57) ABSTRACT

A device for testing a camera module with an actuator is provided. The testing device includes a light emitter, a testing lens member, a light receiver, and a processor. The light receiver emits test light to the camera module. The testing lens member serves as a lens unit of the camera module in a testing process. The testing lens member includes a first lens, and a second lens detachably connected to the first lens. The first lens and the second lens respectively insert into the camera module from two opposite sides of the camera module, and abut two opposite sides of the actuator. The light receiver receives test light emitted from the light emitter and passed through the camera module. The processor determines a quality of the camera module according to the test light received by the light receiver.

### BACKGROUND

1. Technical Field

The present disclosure relates to a testing device and a testing lens member for testing a camera module.

2. Description of Related Art

Camera modules include a lens module and an actuator for varying a focal length of the lens module. To ensure quality, the camera module needs to pass various tests to determine if parameter values of the camera module, such as a path of the actuator, static tilting angles, and dynamic angles, are acceptable. During testing, a testing lens member is employed and mounted to the camera module. However, the testing lens is easily separated from the camera module when the camera module is repositioned or reoriented during testing.

Therefore, what is needed is a testing device and a testing lens for the camera module addressing the limitations described.

### BRIEF DESCRIPTION OF THE DRAWINGS

The components of the drawings are not necessarily drawn to scale, the emphasis instead being placed upon clearly illustrating the principles of the embodiments of the present disclosure. Moreover, in the drawings, like reference numerals designate corresponding parts throughout several views.

FIG. 1 is a schematic view of a testing device for testing a camera module according to one embodiment, the testing device including a testing lens member.

FIG. 2 is an exploded view of the testing lens member of FIG. 1.

FIG. 3 is a cross-sectional view of the testing lens member and the camera module of FIG. 1, taken along line III-III.

### DETAILED DESCRIPTION

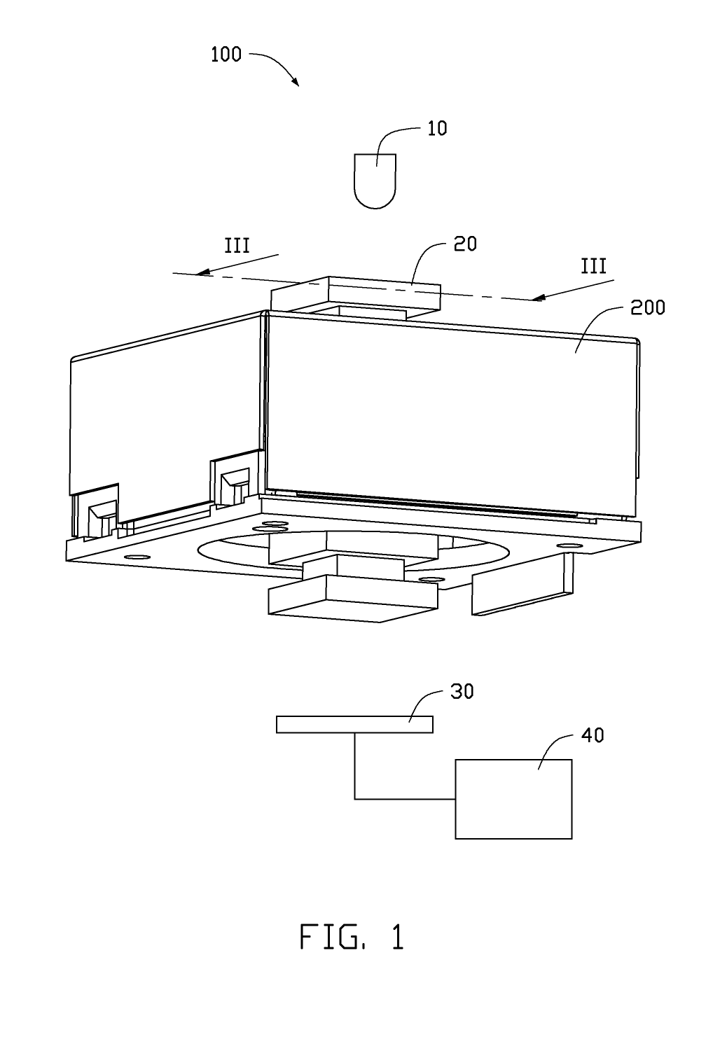

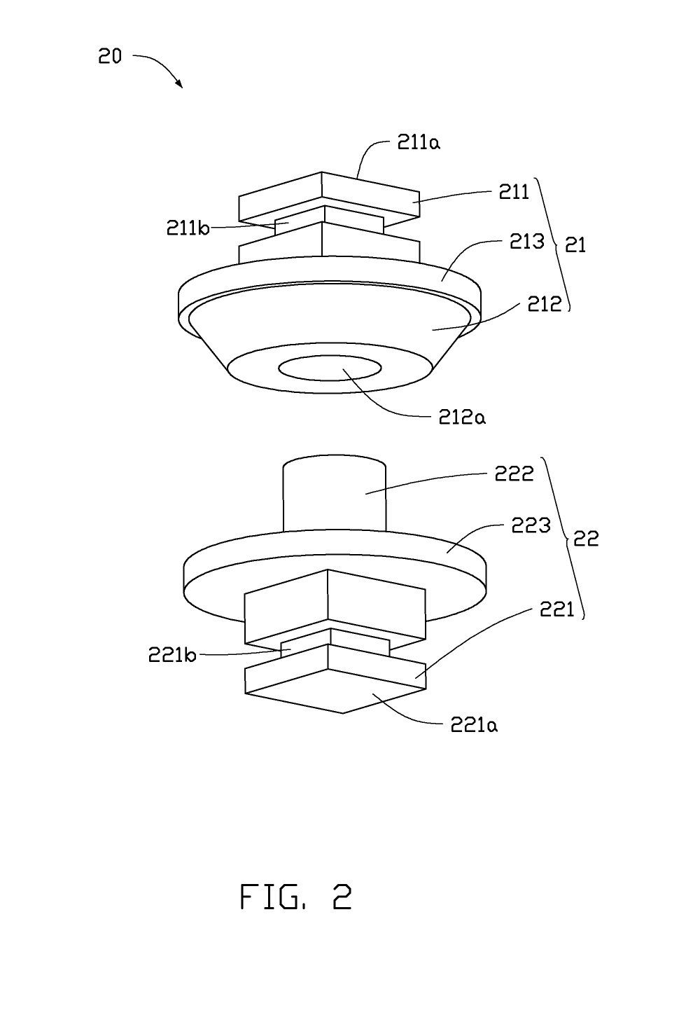

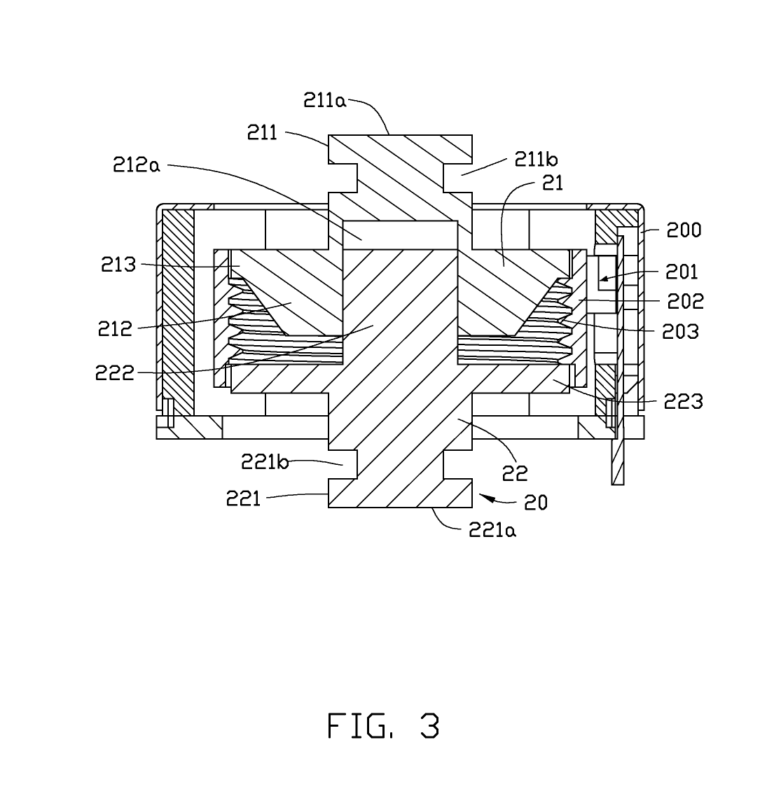

FIGS. 1-3 show one embodiment of a testing device 100 for testing a camera module 200. The camera module 200 includes an actuator 201 for driving a focusing lens (not shown) to move along an optical axis of the camera module 200. The actuator 201 includes a hollow holding member 202 for holding the focusing lens therein.

The testing device 100 includes a light emitter 10, a testing lens member 20 received in the camera module 200, a light receiver 30, and a processor 40 electrically connected to the light receiver 30. In a testing process, the light emitter 10, the light receiver 30, and the camera module 200 are fixedly positioned on a mechanism (not shown) can linearly move and/or rotate in a three-dimensional space The light emitter 10 and the light receiver 30 are positioned at two opposite sides of the camera module 200.

The light emitter 10 is configured for emitting light to the testing lens member 20. In this embodiment, the light emitter 10 is a laser diode.

The testing lens member 20 serves as a lens unit of the camera module 200 in testing. The testing lens member 20 includes a first lens 21, and a second lens 22 connected to the first lens 21.

The first lens 21 includes an incident end 211, a first connecting end 212 opposite to the incident end 211, and a first supporting portion 213 formed between the incident end 211 and the first connecting end 212. The incident end 211 is substantially columnar. In this embodiment, a cross section of the incident end 211 is substantially rectangular. The incident end 211 includes an incident surface 211 a away from the first connecting end 212. The first lens 21 defines a first groove 211b in a peripheral side surface of the incident end 211. To pick up the first lens 21, a clamp (not shown) inserts into the first groove 211b to clamp the first lens 21. In this embodiment, the first groove 211b surrounds the peripheral side surface of the incident end 211. The first lens 21 defines a connecting hole 212a in an end surface of the first connecting end 212. The first supporting portion 213 protrudes from a peripheral side of the first lens 21. In this embodiment, the first supporting portion 213 is substantially ring-shaped. Alternatively, the first supporting portion 213 can be a number of protrusions spaced from each other.

The second lens 22 includes an emergent end 221, a second connecting end 222 opposite to the emergent end 221, and a second supporting portion 223 formed between the emergent end 221 and the second connecting end 222. A shape of the emergent end 221 is substantially the same as that of the incident end 211. The emergent end 221 includes an emergent surface 221 a away from the second connecting end 222. The second lens 22 defines a second groove 221b in a peripheral side surface of the emergent end 221. The second groove 221b has a substantially similar function as that of the first groove 211b. A size and shape of the second connecting end 222 correspond to those of the connecting hole 212a, respectively.

The first lens 21 and the second lens 22 respectively insert into the camera module 200 from two opposite sides of the holding member 202. The second connecting end 222 inserts into the connecting hole 212a of the first connecting end 212. The first supporting portion 213 and the second supporting portion 223 each abut two opposite side surfaces of the holding member 202. The incident surface 211a faces toward the light emitter 10, and the emergent surface 221a faces toward the light receiver 30. In this embodiment, the holding member 202 includes an inner threaded portion 203 formed on an inner surface of the holding member 202. The first supporting portion 213 and the second supporting portion 223 respectively abut two opposite ends of the inner threaded portion 203.

The light receiver 30 is configured for receiving light emitted from the light emitter and passed through the testing lens member 20. In this embodiment, the light receiver 30 is a charge-coupled device (CCD) or a complementary metal-oxide semiconductor (CMOS).

The processor 40 is configured for testing a quality of the camera module 200 according to light received by the light receiver 30. In particular, the processor 40 tests static tilting angles and dynamic angles of the camera module 200 at different positions.

In use, the light emitter 10 emits a test light to the incident surface 211a of the testing lens member 20. The test light passes through the first lens 21 and the second lens 22, passes out of the testing lens member 20 from the emergent surface 221a, and projects onto the light receiver 30. The light receiver 30 receives test light from the testing lens member 20. The processor 40 determines a tilting angle of the camera module according to the test light received by the light receiver 30, and according to a predetermined axial focal point of the light on the light receiver 30. In the testing process, the light emitter 10, the camera module 200, and the light receiver 30 can be rotated by the mechanism. If a central axis of the holding member 202 is titled relative to a predetermined optical axis of the camera module 200, the light received by the light receiver 30 is changed accordingly. Thus, the processor 40 determines a tilting angle of the camera module 200 according to a change of light received by the light receiver 30. Because the testing lens member 20 abuts two opposite side surfaces of the holding member 202, the testing lens member 20 is prevented from falling out of the camera module 200 during the testing process, and it is convenient to test the camera module.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A testing device for testing a camera module with an actuator, comprising:
a light emitter for emitting test light to the camera module;
a testing lens member serving as a lens unit of the camera module in a testing process, the testing lens member comprising a first lens and a second lens detachably connected to the first lens, the first lens and the second lens respectively inserting into the camera module from two opposite sides of the camera module and abutting on two opposite sides of the actuator;
a light receiver for receiving the test light emitted for the light emitter and passing through the camera module; and
a processor for determining a quality of the camera module according to the test light received by the light receiver.

2. The testing device of claim 1, wherein the light emitter is a laser diode.

3. The testing device of claim 1, wherein the first lens comprises an incident end and a first connecting end opposite to the incident end, the second lens comprises an emergent end and a second connecting end opposite to the emergent end, the first connecting end and the second connecting end are connected to each other, the incident end faces toward the light emitter, and the emergent end faces toward the light receiver.

4. The testing device of claim 3, wherein the first lens comprises a first supporting portion formed between the incident end and the first connecting end, the second lens comprises a second supporting portion formed between the emergent end and the second connecting end, the first supporting portion and the second supporting portion respectively abuts on two opposite side surfaces of the actuator.

5. The testing device of claim 3, wherein the first lens defines a first groove in a peripheral side surface of the incident end, and the second lens defines a second groove in a peripheral side surface of the emergent end.

6. The testing device of claim 5, wherein the first groove and is continuously surrounding the peripheral side surface of the incident end.

7. The testing device of claim 3, wherein the first lens defines a connecting hole in an end surface of the first connecting end, the second connecting end is received in the connecting hole.

8. The testing device of claim 1, wherein the light receiver is selected from a group consisting a charge-coupled device and a complementary metal oxide semiconductor.

9. A testing lens member for testing a camera module with an actuator, comprising:
a first lens; and
a second detachable connected to the first lens;
wherein the first lens and the second lens respectively insert into the camera module from two opposite sides of the camera module and abut on two opposite sides of the actuator.
